(19) United States
(12) Patent Application Publication
(10) Pub. No.: US 2013/0286232 A1
(43) Pub. Date: Oct. 31, 2013

(54) USE OF CLOSE PROXIMITY COMMUNICATION TO ASSOCIATE AN IMAGE CAPTURE PARAMETER WITH AN IMAGE

(71) Applicant: Dhawal S. Sheth, San Diego, CA (US)

(72) Inventor: Dhawal S. Sheth, San Diego, CA (US)

(73) Assignee: MOTOROLA MOBILITY, INC., Libertyville, IL (US)

(21) Appl. No.: 13/460,051

(22) Filed: Apr. 30, 2012

(51) Int. Cl. H04N 5/225; H04B 5/00

(52) U.S. Cl. 348/207.11; 348/E05.024

(57) ABSTRACT

Associating an image capture parameter with an image. Via an image capture device, the image capture parameter can be received from a transmit device via close proximity communication. Via the image capture device, the image can be captured. Via the image capture device, the image capture parameter can be automatically associated with the captured image.

### BACKGROUND OF THE INVENTION

The use of digital image capture is common place throughout the industrialized world. In this regard, the use of digital cameras has largely replaced traditional cameras which capture images on film. A digital camera is a camera that captures images via an electronic image sensor, such as a charge-coupled device (CCD) or a complementary metal-oxide-semiconductor (CMOS) sensor, and stores the images. Digital cameras sometimes are stand-alone devices, and sometimes are integrated into other devices. Examples of such other devices include mobile phones (e.g., smart phones), desktop computers, tablet computers, laptop computers, and the like.

### BRIEF DESCRIPTION OF THE DRAWINGS

FIG. 1 depicts a system that is useful for understanding various arrangements described herein.

FIG. 2 depicts an example of a captured image that is useful for understanding various arrangements described herein.

FIG. 3 depicts a block diagram of an image capture device, which is useful for understanding various arrangements described herein.

FIG. 4 depicts a block diagram of a transmit device, which is useful for understanding various arrangements described herein.

FIG. 5 is a flowchart presenting a method of associating an image capture parameter with an image, which is useful for understanding various arrangements described herein.

FIG. 6 is a flowchart presenting a method of associating an image capture parameter with an image, which is useful for understanding various arrangements described herein.

### DETAILED DESCRIPTION

While the specification concludes with claims defining features of the embodiments described herein that are regarded as novel, it is believed that these embodiments will be better understood from a consideration of the description in conjunction with the drawings. As required, detailed arrangements of the present embodiments are disclosed herein; however, it is to be understood that the disclosed arrangements are merely exemplary of the embodiments, which can be embodied in various forms. Therefore, specific structural and functional details disclosed herein are not to be interpreted as limiting, but merely as a basis for the claims and as a representative basis for teaching one skilled in the art to variously employ the present embodiments in virtually any appropriately detailed structure. Further, the terms and phrases used herein are not intended to be limiting but rather to provide an understandable description of the present arrangements.

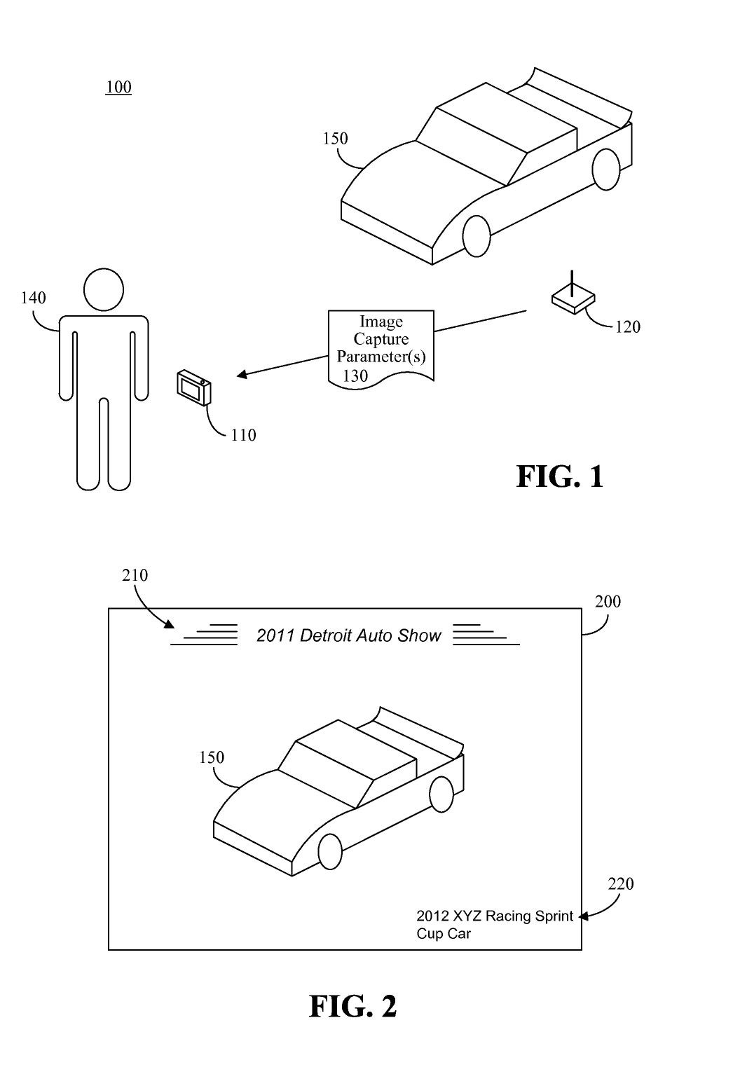

FIG. 1 depicts a system 100 that is useful for understanding various arrangements described herein. The system 100 can include an image capture device 110. In one arrangement, the image capture device 110 can be a camera, such as a digital camera. In another arrangement, the image capture device 110 can be a mobile communication device that includes a digital imaging device (e.g., camera), for example a mobile phone (e.g. a smart phone), a personal digital assistant (PDA), a tablet computer, a mobile computer, a laptop computer, or any other type of mobile communication device that includes a digital imaging device. The digital imaging device can be configured to capture still images and/or video.

The system 100 also can include a transmit device 120 that transmits at least one image capture parameter (hereinafter “parameter”) 130. The transmit device 120 can include a transmitter, which may exclusively transmit signals or be embodied as a transceiver that both transmits signals and receives signals. In one arrangement, the transmit device 120 can be an application specific device that includes, or is communicatively linked, to a data storage device on which the parameter(s) 130 are stored. In another arrangement, the transmit device 120 can be a mobile phone, a PDA, a computer, a tablet computer, a mobile computer, a laptop computer, or any other type of communication device that includes a transmitter (or transceiver).

The transmit device 120 can transmit the parameter(s) 130 in accordance with a close proximity communication protocol. As used herein, the term close proximity communication means wireless communication between at least two devices over a short distance, for example less than 10 meters, less than 5 meters, less than 4 meters, less than 3 meters, less than 2 meters, less than 1 meter, less than 10 centimeters, less than 5 centimeters, less than 4 centimeters, less than 3 centimeters, less than 2 centimeters, or less than 1 centimeter.

One example of a close proximity protocol is a near field communication (NFC) protocol. The NFC protocol can be specified in accordance with radio-frequency identification (RFID) standards including, but not limited to, ISO/IEC 14443, ISO/IEC 18092 and FeliCa. Another example of a close proximity protocol is a personal area network (PAN) protocol, such as Bluetooth® or ZigBee®, though the present arrangements are not limited to these specific examples. Other examples of close proximity protocols are wireless infrared (IR) communication protocols. Still, other close proximity protocols may be used and the present arrangements are not limited in this regard.

The transmit device 120 can transmit the parameter(s) 130 to the image capture device 110 via close proximity communications. For example, in one arrangement, the transmit device 120 can transmit the parameter(s) 130 over a small geographic region (e.g., less than 10 meters, less than 5 meters, less than 4 meters, less than 3 meters, less than 2 meters, less than 1 meter, less than 10 centimeters, less than 5 centimeters, less than 4 centimeters, less than 3 centimeters, less than 2 centimeters, or less than 1 centimeter from the transmit device 120), and the image capture device 110 can detect the transmitted parameter(s) 130.

In another arrangement, the transmit device 120 can broadcast a beacon signal. The image capture device 110 can detect the beacon signal, and initiate an exchange of communication signals with the transmit device 120 to establish a communication link, for example in accordance with a suitable PAN protocol. The transmit device 120 can communicate the parameter(s) 130 to the image capture device 110 over the established communication link. When the image capture device 110 detects the beacon signal, the image capture device 110 can prompt a user 140 to enter a user input into the image capture device 110 to indicate whether the user authorizes the communication link to be established. If the user input indicates the communication link is authorized, the communication link can be established. If not, the image capture device 110 need not establish the communication link.

Responsive to the image capture device 110 receiving the parameter(s) 130, the image capture device 110 can automatically initiate image capture functionality on the image capture device 110. For example, if the image capture device 110 is a digital camera, the image capture device 110 can enter itself into a state in which the image capture device 110 is ready to capture at least one image (e.g., take a picture and/or record video). This may include initiating a camera application on the image capture device 110, opening a lens cover and/or taking the image capture device 110 out of a sleep state, a standby state, a picture/video viewing state, or any other present state the image capture device 110. When the camera application is initiated, the image capture device 110 can enter into a state in which it is ready to capture one or more images. If the image capture device 110 does not support multi-tasking, any other applications that are open can be automatically closed, and corresponding data can be saved, when the camera application is initiated.

In one non-limiting example, the image capture device 110 can be in a state other than a state in which the image capture device 110 is ready to capture an image. The user 140 can pass the image capture device 110 near the transmit device 120. For example, if the transmit device 120 transmits the parameters 130 in accordance with a NFC protocol, the user 120 can pass the image capture device 110 within a few centimeters of the transmit device 120, or even touch the image capture device 110 to the transmit device 120. When the image capture device 110 is passed by the transmit device 120 within a few centimeters, or touched to the transmit device 120, the image capture device 110 can receive the parameters 130 from the transmit device 120 and process such parameters 130. If the transmit device 120 transmits the parameters 130 in accordance with a PAN or IR protocol, the image capture device can receive the parameters 130 when the image capture device is within range of the transmit device's transmissions. In response to processing the parameters, the image capture device 110 can enter into the image capture state.

Further, initiating the image capture functionality on the image capture device 110 can include initiating the image capture functionality with image capture settings corresponding to the parameter(s) 130. In this regard, when the image capture device 110 enters the state in which it is ready to capture one or more images, one or more of the parameter(s) 130 can be associated with the captured images. As used herein, the term “associate” means to create a relationship in a manner that is capable of being precisely identified.

In illustration, in one example, the parameter(s) 130 can include one or more image format parameter(s), which can be associated with the captured image by configuring the image capture device 110 in accordance with the image format parameter(s) so that when an image is captured, the image is formatted as specified by the image format parameter(s). For instance, the image format parameter(s) can indicate image effects to be applied to a captured image, indicate a second image that is to be added to the captured image, and the like. In another example, the parameter(s) 130 can specify metadata that is to be overlaid onto a captured image and/or inserted into an image file that contains the captured image. In this regard, the metadata can be inserted into an image file that is formatted in accordance with a suitable image file format, such as an exchangeable image file format (EXIF). The metadata can be inserted into a header, footer or body of the image file.

By way of example, assume the user of the image capture device 110 is attending a car show, the transmit device 120 can be located in, on or near a car 150, or the transmit device 120 can be mounted on a stand close to the exhibit with a message on the stand that indicates to users that they can tag their image capture devices to capture creative pictures. When the image capture device 110 is in close proximity to the transmit device 120, the image capture device 110 can receive the image capture parameter(s) 130 from the transmit device 120, as previously described. The parameter(s) 130 can indicate to the image capture device 110 that when an image is captured, the image is to be formatted as a black and white image, formatted to accentuate one or more colors, formatted to accentuate certain features of the image, and/or to provide any other image effects in the image. The parameter(s) 130 also can define a second image, such as a bitmap image, that is to be overlaid onto the captured image, for example a fun frame that is to be applied around the periphery of the image, a logo or text that is to be presented in the image, and the like. Thus, when the user 140 captures an image of the car 150 with the image capture device 110, the image effects and or second image can be applied to the captured image of the car.

Further, the parameter(s) 110 can indicate an image tag, such as an EXIF tag or other suitable tag that is to be applied to the captured image. When the user 140 captures an image of the car 150 with the image capture device 110, the image tag can be associated with the captured image, for example as metadata. In illustration, the image tag can indicate a make, model and/or year of the car 150, the event in which the car 150 is on display, where the event took place, etc. When the user shares the captured image with other people, the image tag can accompany the image and be viewed by such other people. In one arrangement, the metadata can be overlaid onto the captured image, though the present arrangements are not limited in this regard.

FIG. 2 depicts an example of a captured image 200 that is useful for understanding various arrangements described herein. The image can include the car 150. Visual effects (not shown) can be applied to the car, as previously described. Further, a second image 210 can be overlaid onto the captured image 200, and metadata 220 can be associated with the image. For example, the metadata 220 can be overlaid onto the image, and/or otherwise associated with the image file in a suitable manner. At this point it should be noted that the present arrangements are not limited to use at a car show or with cars, but can be implemented virtually anywhere. For example, the present arrangements can be implemented at a park, an amusement park, an aquarium, a sporting event, a concert, a play, a social event, a school, a workplace, a restaurant, and so on.

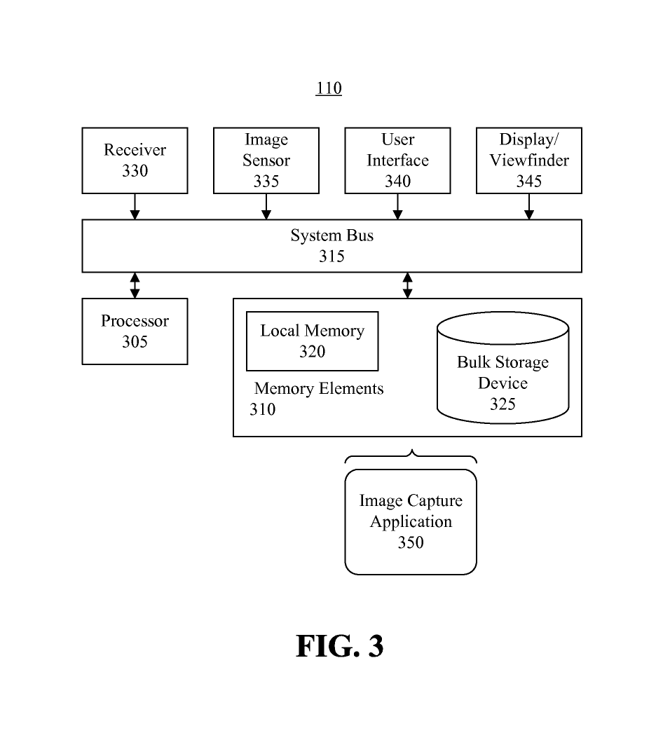

FIG. 3 depicts a block diagram of an image capture device 110, which is useful for understanding various arrangements described herein. The image capture device 110 can include at least one processor 305 coupled to memory elements 310 through a system bus 315 or other suitable circuitry. As such, the image capture device 110 can store program code within memory elements 310. The processor 305 can execute the program code accessed from memory elements 310 via the system bus 315. The image capture device 110 can be implemented as a digital camera or mobile communication device that is suitable for storing and/or executing program code. It should be appreciated, however, that the image capture device 110 can be implemented in the form of any system including a processor and memory that is capable of performing the functions and/or operations described within this specification as being performed by the image capture device 110.

The memory elements 310 can include one or more physical memory devices such as, for example, local memory 320 and one or more bulk storage devices 325. Local memory 320 refers to RAM or other non-persistent memory device(s) generally used during actual execution of the program code. The bulk storage device(s) 325 can be implemented as a hard disk drive (HDD), a solid state drive (SSD), read-only memory (ROM), erasable programmable read-only memory (EPROM or Flash memory), or other persistent data storage device. The image capture device 110 also can include one or more cache memories (not shown) that provide temporary storage of at least some program code in order to reduce the number of times program code must be retrieved from the bulk storage device 325 during execution.

The image capture device 110 also can include input/output (I/O) devices, such as a receiver 330, an image sensor 335 and a user interface 340. The image capture device 110 further can include a display and/or viewfinder 345. The I/O devices can be coupled to processor 305 either directly through the system bus 315 or through intervening I/O controllers.

The receiver 330 can be configured to receive wirelessly propagated signals, as is known to those skilled in the art. As noted, the receiver can be embodied as a transceiver, though this need not be the case. In one arrangement, the receiver can be a NFC receiver configured to receive signals in accordance with ISO/IEC 14443, ISO/IEC 18092, FeliCa or any other suitable NFC protocols. For example, the receiver 330 can be communicatively linked to an antenna coil via which the receiver 330 inductively couples to one or more other devices, such as the transmit device previously discussed. The receiver 330 can be configured to demodulate NFC signals received from one or more other devices to baseband signals, and retrieve the parameters from the baseband signals.

In another arrangement, the receiver 330 can be configured to receive radio frequency (RF) signals via an antenna in accordance with a suitable PAN protocol, such as Bluetooth® or ZigBee®, receive infrared (IR) signals via an IR detection sensor in accordance with a suitable IR protocol, or the receiver 330 can be configured to receive wireless signals in accordance with any other suitable close proximity communication protocols. The receiver 330 can be configured to demodulate RF and/or IR signals received from one or more other devices to baseband signals, and retrieve the parameters from the baseband signals.

The image sensor 335 can be a charge-coupled device (CCD), a complementary metal-oxide-semiconductor (CMOS) sensor, or any other digital imaging device or sensor that is suitable for capturing still images and/or video. Image sensors are well known to those skilled in the art. The user interface 340 can include a button, key, soft key, input audio transducer/audio processor, or any other component that is configured to receive a user input to initiate capture of an image on the image capture device 110. The user input can be a tactile input or a spoken utterance.

The display and/or viewfinder 345 can be configured to present a view of an area where the image sensor 335 is pointing, and thus display an area to be captured in an image when the user interface 340 receives a user input to capture the image. Displays and viewfinders are well known in the art. In one arrangement, the user interface can be presented via the display 345. For example, the display 345 can comprise a touchscreen configured to receive the user input to initiate capture of an image on the image capture device 110.

As pictured in FIG. 3, the memory elements 310 can store an image capture application 350. The image capture application 350, being implemented in the form of executable program code, can be executed by the processor 305 and, as such, can be considered part of the image capture device 110. The image capture application 350 can receive the image capture parameters received by the image capture device 110 via the receiver 330, and implement the methods and processes described herein that are performed by the image capture device 110 to associate the image capture parameter with the captured image, initiate image capture functionality on the image capture device, and perform other suitable functions and/or processes.

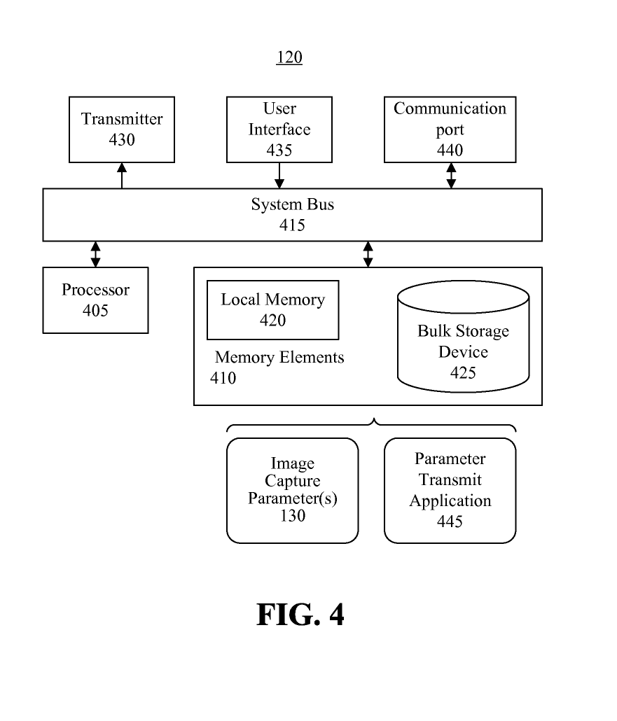

FIG. 4 depicts a block diagram of a transmit device 120, which is useful for understanding various arrangements described herein. The transmit device 120 can include at least one processor 405 coupled to memory elements 410 through a system bus 415 or other suitable circuitry. As such, the transmit device 120 can store program code within memory elements 410. The memory elements 410 can include one or more physical memory devices such as, for example, local memory 420 and one or more bulk storage devices 425. The processor 405 can execute the program code accessed from memory elements 410 via the system bus 415. As noted, the transmit device 120 can be in the form of any system including a processor and memory that is capable of performing the functions and/or operations described within this specification as being performed by the transmit device.

The transmit device 120 also can include input/output (I/O) devices, such as a transmitter 430 and a user interface 435. Optionally, in addition to, or in lieu of, the user interface 435, the transmit device can include a communication port 440. The I/O devices can be coupled to processor 405 either directly through the system bus 415 or through intervening I/O controllers.

The transmitter 430 can wirelessly transmit signals, as is known to those skilled in the art. As noted, the transmitter 430 can be embodied as a transceiver, though this need not be the case. In one arrangement, the transmitter 430 can be a NFC transmitter configured to transmit signals in accordance with ISO/IEC 14443, ISO/IEC 18092, FeliCa or any other suitable NFC protocols. For example, the transmitter 430 can be communicatively linked to an antenna coil via which the transmitter 430 inductively couples to one or more other devices, such as the image capture device previously discussed. The transmitter 430 can be configured to modulate baseband signals containing the image capture parameters 130 to NFC signals, and transmit the NFC signals.

In another arrangement, the transmitter 430 can be configured to transmit RF signals via an antenna in accordance with a suitable PAN protocol, such as Bluetooth® or ZigBee®, transmit IR signals via a light emitting diode (LED), or other suitable IR source, in accordance with a suitable wireless IR protocol, or the transmitter 430 can be configured to communicate in accordance with any other suitable close proximity communication protocols. The transmitter 430 can be configured to modulate baseband signals containing the image capture parameters 130 to RF and/or IR signals, and transmit the RF and/or IR signals.

The user interface 435 can comprise any suitable user interface devices, such as buttons, keys, soft keys, a touch screen, etc., to receive the image capture parameters 130 from a user and store the parameters 130 to the memory elements 410. In another arrangement, the parameters 130 can be received via the communication port 440. For example, the parameters 130 can be received from another device that communicatively links to the transmit device 120 via the communication port 440. The communication port 440 can be a wired or a wireless communication port.

As pictured in FIG. 4, the memory elements 410 further can store a parameter transmit application 445. The parameter transmit application 445, being implemented in the form of executable program code, can be executed by the processor 405 and, as such, can be considered part of the transmit device 120. The parameter transmit application 445 can access the parameters 130, and implement the methods and processes described herein that are performed by the transmit device 120 to transmit the parameters via the transmitter 430.

FIG. 4 is but one example of a transmit device 120. In other arrangements, the transmit device 120 can include additional components or fewer components. For example, in an arrangement in which the transmit device 120 is a mobile communication device, the transmit device may include a touchscreen, input/output audio transducers, etc. Further, the transmit device 120 can be implemented simply as a transmitter 430 that receives the parameters 130 from another device, or a transmitter programmable to transmit the parameters 130.

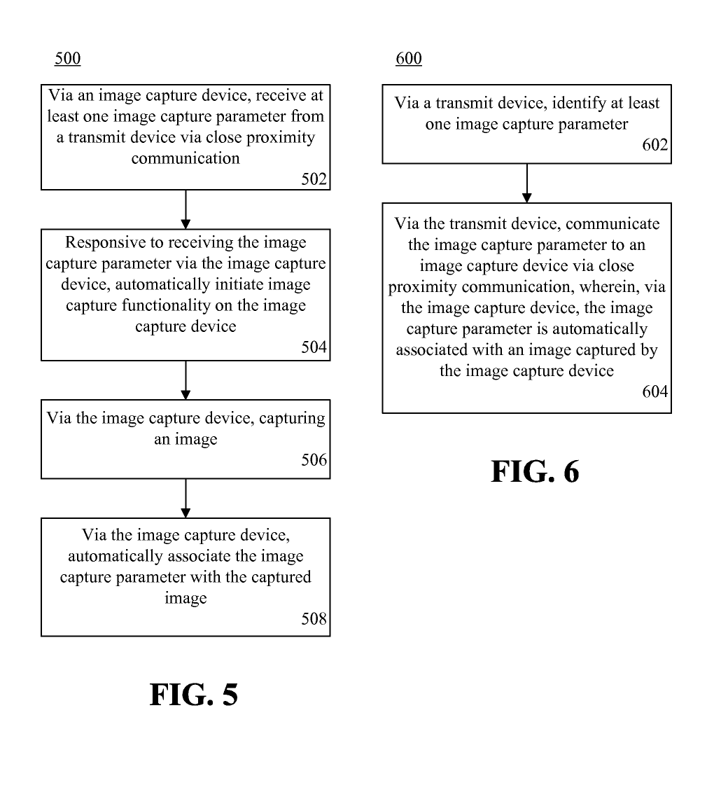

FIG. 5 is a flowchart presenting a method of associating an image capture parameter with an image, which is useful for understanding various arrangements described herein. At step 502, via an image capture device, at least one image capture parameter can be received from a transmit device via close proximity communication, for example in accordance with a NFC protocol, a PAN protocol or an IR protocol. At step 504, responsive to receiving the image capture parameter via the image capture device, image capture functionality can be automatically initiated on the image capture device. In one non-limiting example, a camera application on a mobile communication device can be initiated. Further, the image capture functionality can be initiated with image capture settings corresponding to the image capture parameter. For instance, the image capture parameters can include one or more image format parameters, which can be applied to the image capture device to format captured images in accordance with the image format parameters.

At step 506, via the image capture device, an image can be captured. At step 508, via the image capture device, the image capture parameter can be automatically associated with the captured image.

In one arrangement, the image capture parameter can include an image format parameter. In such arrangement, associating the image capture parameter with the captured image can include formatting the image in accordance with the image format parameter. For example, a second image corresponding to the image format parameter can be added to the image and/or image effects corresponding to the image format parameter can be applied to the captured image. In another arrangement, receiving the image capture parameter on the image capture device can include receiving an image tag. In such arrangement, the image tag can be associated with the captured image as metadata.

FIG. 6 is a flowchart presenting a method of associating an image capture parameter with an image, which is useful for understanding various arrangements described herein. At step 602, via a transmit device, at least one image capture parameter can be identified. For example, the image capture parameter can be accessed from memory elements of the transmit device or received from another device communicatively linked to the transmit device. At step 604, via the transmit device, the image capture parameter can be communicated to an image capture device via close proximity communication, for example in accordance with a NFC protocol, a PAN protocol or an IR protocol. Via the image capture device, the image capture parameter can be automatically associated with an image captured by the image capture device.

The image capture parameter can initiate image capture functionality on the image capture device. In one non-limiting example, the image capture parameter can initiate a camera application on a mobile communication device. Further, the image capture functionality can be initiated in the image capture device with image capture settings corresponding to the image capture parameter.

In one arrangement, the image capture parameter can be an image format parameter. In such arrangement, the image capture device can format the image in accordance with the image format parameter. For example, a second image corresponding to the image format parameter can be added to the image and/or image effects corresponding to the image format parameter can be applied to the captured image. In another arrangement, the image capture parameter can be an image tag. In such arrangement, the image tag can be associated with the captured image as metadata by the image capture device.

The flowcharts and block diagrams in the figures illustrate the architecture, functionality, and operation of possible implementations of systems, methods and computer program products according to various embodiments described herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present embodiments can be realized in hardware, or a combination of hardware and software. The present embodiments can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-readable (or computer-usable) program code that, when being loaded and executed by one or more processors, controls the processing system such that it carries out the methods described herein. The present embodiments also can be embedded in a computer program product comprising a non-transitory computer-readable storage medium, readable by a machine, tangibly embodying a program of instructions executable by the processing system to perform methods and processes described herein. The present embodiments also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one level of voltage, touch sensor, object, region, portion or the like from another message, signal, item, object, device, system, apparatus, step, process, or the like. Thus, an ordinal term used herein need not indicate a specific position in an ordinal series. For example, a process identified as a “second touch sensor” may occur before a touch sensor identified as a “first touch sensor.” Further, one or more processes may occur between a first process and a second process.

These embodiments can be embodied in other forms without departing from the spirit or essential attributes thereof. Accordingly, reference should be made to the following claims, rather than to the foregoing specification, as indicating the scope of the embodiments.

What is claimed is:

1. A method of associating an image capture parameter with an image, the method comprising:
via an image capture device, receiving at least one image capture parameter from a transmit device via close proximity communication;
via the image capture device, capturing the image; and
via the image capture device, automatically associating the image capture parameter with the captured image.

2. The method of claim 1, wherein the close proximity communication is implemented in accordance with a near field communication protocol.

3. The method of claim 1, further comprising:
responsive to receiving the image capture parameter via the image capture device, automatically initiating image capture functionality on the image capture device.

4. The method of claim 3, wherein initiating the image capture functionality on the image capture device comprises:
initiating a camera application on a mobile communication device.

5. The method of claim 3, wherein initiating the image capture functionality on the image capture device comprises:
initiating the image capture functionality with image capture settings corresponding to the image capture parameter.

6. The method of claim 1, wherein:
receiving the image capture parameter on the image capture device comprises receiving an image format parameter; and
associating the image capture parameter with the captured image comprises formatting the image in accordance with the image format parameter.

7. The method of claim 6, wherein formatting the image in accordance with the image format parameter comprises:
adding to the captured image a second image corresponding to the image format parameter.

8. The method of claim 6, wherein formatting the image in accordance with the image format parameter comprises:
applying image effects corresponding to the image format parameter to the captured image.

9. The method of claim 1, wherein:
receiving the image capture parameter on the image capture device comprises receiving an image tag; and
associating the image capture parameter with the captured image comprises associating the image tag with the captured image as metadata.

10. A method of associating an image capture parameter with an image, the method comprising:
via a transmit device, identifying at least one image capture parameter; and
via the transmit device, communicating the image capture parameter to an image capture device via close proximity communication, wherein, via the image capture device, the image capture parameter is automatically associated with an image captured by the image capture device.

11. The method of claim 10, wherein the close proximity communication is implemented in accordance with a near field communication protocol.

12. The method of claim 10, wherein the image capture parameter initiates image capture functionality on the image capture device.

13. The method of claim 12, wherein initiating the image capture functionality on the image capture device comprises:
initiating a camera application on a mobile communication device.

14. The method of claim 12, wherein:
the image capture functionality is initiated in the image capture device with image capture settings corresponding to the image capture parameter.

15. The method of claim 10, wherein:
communicating the image capture parameter to the image capture device comprises communicating an image format parameter; and
the image capture device formats the image in accordance with the image format parameter.

16. The method of claim 15, wherein:
the image capture devices formats the image in accordance with the image format parameter by adding to the captured image a second image corresponding to the image format parameter.

17. The method of claim 15, wherein:
the image capture devices formats the image in accordance with the image format parameter by applying image effects to the captured image.

18. The method of claim 10, wherein:
communicating the image capture parameter to an image capture device comprises communicating an image tag; and
the image tag is associated with the captured image as metadata by the image capture device.

19. An image capture device, comprising:
a receiver that receives at least one image capture parameter from a transmit device via close proximity communication;
an image sensor that captures an image; and
a processor configured to initiate executable operations comprising associating the image capture parameter with the captured image.

20. The image capture device of claim 19, wherein the close proximity communication is implemented in accordance with a near field communication protocol.

21. The image capture device of claim 19, wherein the processor further is configured to initiate executable operations comprising:
responsive to receiving the image capture parameter via the receiver, automatically initiating image capture functionality on the image capture device.

22. A transmit device, comprising:
a processor configured to initiate executable operations comprising identifying at least one image capture parameter; and
a transmitter that communicates the image capture parameter to an image capture device via close proximity communication, wherein, via the image capture device, the image capture parameter is automatically associated with an image captured by the image capture device.

23. The image capture device of claim 22, wherein the close proximity communication is implemented in accordance with a near field communication protocol.

24. The method of claim 22, wherein the image capture parameter initiates image capture functionality on the image capture device.
